(19) United States
(12) Patent Application Publication
(10) Pub. No.: US 2017/0171030 A1
(43) Pub. Date: Jun. 15, 2017

(54) SYSTEM AND METHOD FOR DIGITAL OPTIMIZATION OF ELECTRONIC DISCOVERY

(71) Applicant: Precision Discovery, New York, NY (US)

(72) Inventors: Drew Meshreky, Corona, CA (US); Timothy Ross, Parker, CO (US)

(21) Appl. No.: 15/379,304

(22) Filed: Dec. 14, 2016

Related U.S. Application Data
(60) Provisional application No. 62/267,107, filed on Dec. 14, 2015.

(51) Int. Cl. H04L 12/24

(52) U.S. Cl. CPC H04L 41/12; H04L 41/14

(57) ABSTRACT

Electronic discovery information associated with processed metrics for collected assets from a plurality of custodians is provided via a data communication platform. A plurality of custodians associated with electronic discovery are identified, as well as a plurality of respective assets that have been maintained by the custodians. Event information representing metrics, including physical specifications of each of the respective assets and third party reviewer forensic activity, is received. For each of the assets, the processor determines a time and/or cost completion estimation associated with the forensic activity. Furthermore, the processor receives a request associated with the electronic discovery. In response, the processor prepares the electronic discovery information that includes the time and/or cost completion determination for at least one of the collected assets. Thereafter, the processor is configured to provide, in response to the request over a communication network, the electronic discovery information.

### CROSS-REFERENCE TO RELATED APPLICATIONS

The present application claims priority to U.S. Patent Provisional Patent Application Ser. No. 62/267,107, entitled “SYSTEM AND METHOD FOR DIGITAL OPTIMIZATION OF ELECTRONIC DISCOVERY” filed Dec. 14, 2015, the contents of which is hereby incorporated by reference as if set forth expressly in its respective entirety herein.

### FIELD OF THE INVENTION

The present invention relates, generally, to networking and, more particularly, to systems and methods for managing electronic discovery information associated with processed metrics for collected assets from a plurality of custodians.

### BACKGROUND

Creation of digital data in connection with the management of custodians and related assets, both physical and digital, remains challenging as part of the satisfaction of discovery obligations. In particular, identification and management of custodians that are the subject of discovery requests, as well as data concerning the identification and collection of assets maintained by such custodians may be inefficient, time consuming and expensive.

### SUMMARY

Accordingly, a system and method are disclosed for providing, via a data communication platform, electronic discovery information associated with processed metrics for collected assets from a plurality of custodians. A processor configured by executing code identifies a plurality of custodians associated with electronic discovery, as well as a plurality of respective assets that have been maintained by the custodians. The processor is further configured to receive, over a communication network from a plurality of computing devices, event information representing metrics associated with respective ones of the assets. The metrics include physical specifications of each of the respective assets and include third party reviewer forensic activity in relation to each of the respective assets. Moreover, for each of the respective asset(s), the processor determines as a function of processing the event information, a time and/or cost completion estimation associated with the forensic activity. Furthermore, the processor receives over a communication network from a computing device via the data communication platform, a request associated with the electronic discovery. In response, the processor prepares the electronic discovery information that includes the time and/or cost completion determination for at least one of the collected assets. Thereafter, the processor is configured to provide, in response to the request over a communication network, the electronic discovery information.

Other features and advantages of the present invention will become apparent from the following description of the invention that refers to the accompanying drawings.

### BRIEF DESCRIPTION OF DRAWINGS/FIGURES

Further aspects of the present disclosure will be more readily appreciated upon review of the detailed description of its various embodiments, described below, when taken in conjunction with the accompanying drawings, of which:

FIG. 1A is a block diagram illustrating a plurality of devices and components with certain embodiments of the application;

FIG. 1B is a block diagram illustrating an arrangement of hardware and corresponding parties in connection with an example implementation of the present application;

FIG. 2 illustrates example functional elements of an information processor or user computing device, in accordance with example implementations of the present application;

FIG. 3 is a block diagram showing an information processor, a graphical user interface and application programming interface(s), and a series of modules that can be implemented to configure the information processor in accordance with example implementations of the present application;

FIGS. 4-6 provide graphical representations of custodians and assets, and features of the present application associated with ranking reviewers in connection with specific assets; and

FIG. 7 is a flow chart illustrating example steps associated with providing, via a data communication platform, electronic discovery information, in accordance with an example implementation of the present application.

### DETAILED DESCRIPTION

Embodiments of the invention are directed towards systems, methods and computer program products for creation of digital data in connection with providing management of responding to discovery requests. According to one or more embodiments, electronic discovery information associated with processed metrics for collected assets from a plurality of custodians is provided via a data communication platform. In response to a discovery request, the present application implements processes that identify respective electronic assets, such as a smartphone or other a computing device (e.g., tablet, laptop, desktop, server, or the like), that are in possession or maintained by one or more custodians. Other types of assets that are electronic devices capable of data storage can be identified, such as electronic modules configured with processing capability. For example, modules that are installed in a vehicle or in a home/office appliance can comprise assets. In addition to identifying one or more assets, the present application includes processes(s) for identifying one or more reviewers responsible for the review of the one or more assets collected from the one or more custodians. For example, third-party vendors (i.e., reviewers) hired to collect and conduct forensic analysis of identified assets are identified, and information associated with the assets can be received from the reviewers. Such information is processed and used for further determinations associated with electronic discovery operations.

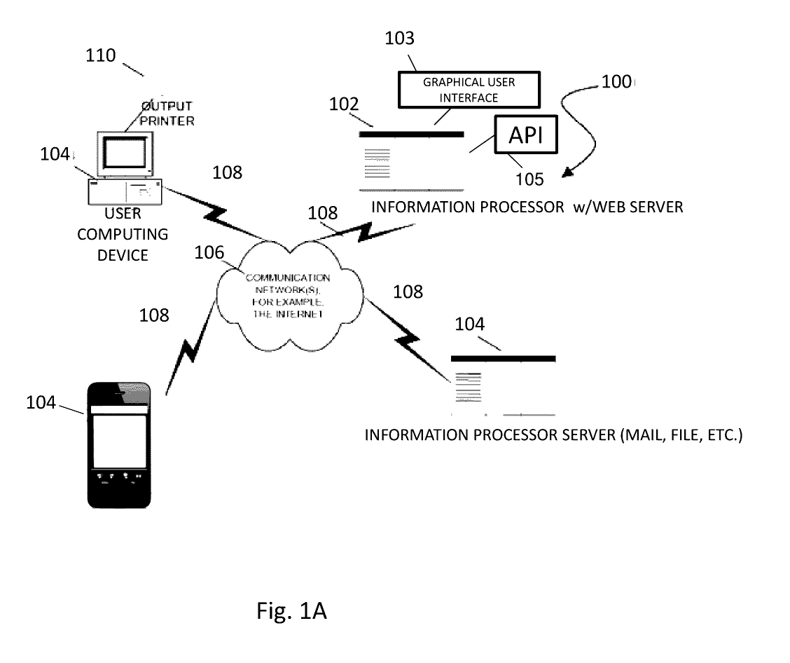

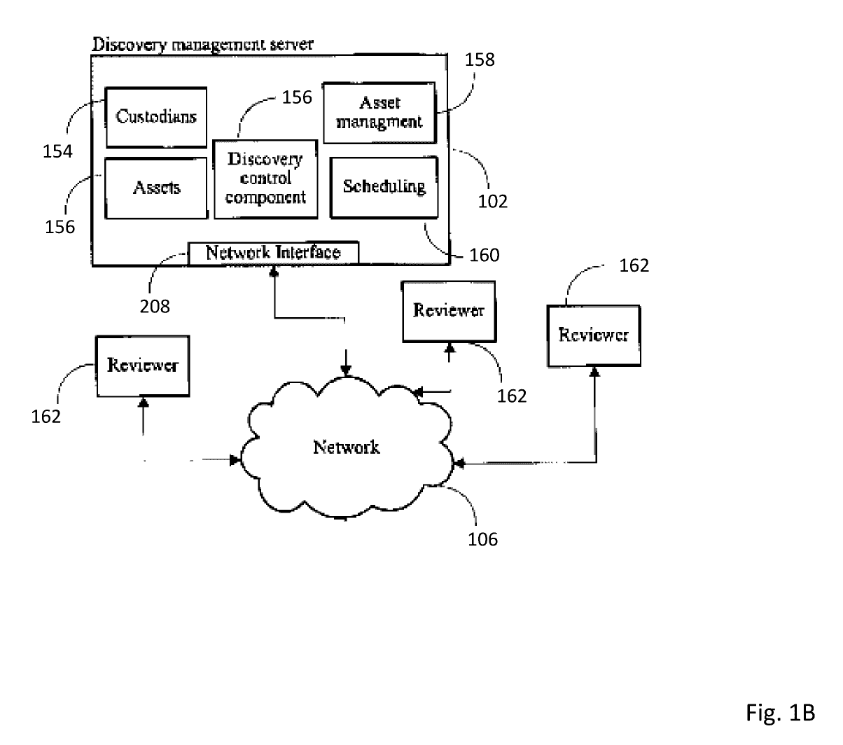

Referring now to the drawings in which like reference numerals refer to like elements, there is shown in FIG. 1A a diagram of an example hardware arrangement that operates for providing the systems and methods disclosed herein, and designated generally as discovery asset management system 100. The example system 100 is preferably comprised of one or more information processor 102 coupled to one or more user computing devices 104 across communication network 106. User computing devices 104 may include, for example, mobile computing devices such as tablet computing devices, smartphones, personal digital assistants or the like. Further, printed output is provided, for example, via output printers 110.

Information processor 102 preferably includes all necessary databases for the present invention, including image files, metadata and other information relating to electronic discovery. However, it is contemplated that information processor 102 can access any required databases via communication network 106 or any other communication network to which information processor 102 has access. Information processor 102 can communicate with devices comprising databases using any known communication method, including a direct serial, parallel, USB interface, or via a local or wide area network. Database(s) that are accessible by information processor 102 can contain and/or maintain various data items and elements that are utilized throughout the various operations of the system (100). For example, the database(s) can include user information including account information concerning the user's various accounts third-party content and service providers. The database(s) can also include user preferences concerning operation of the system 100 and other settings related to the third-party content and service providers.

User computing devices 104 communicate with information processor 102 using data connections 108, which are respectively coupled to communication network 106. Communication network 106 can be any communication network, but is typically the Internet or some other global computer network. Data connections 108 can be any known arrangement for accessing communication network 106, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User computing devices 104 preferably have the ability to send and receive data across communication network 106, and are equipped with web browsers to display the received data on display devices incorporated therewith. By way of example, user computing device 104 may be personal computers such as Intel Pentium-class computers or Apple Macintosh computers, but are not limited to such computers. Other computing devices which can communicate over a global computer network such as palmtop computers, personal digital assistants (PDAs) and mass-marketed Internet access devices, such as a smart television, can be used. In addition, the hardware arrangement of the present invention is not limited to devices that are physically wired to communication network 106. Of course, one skilled in the art will recognize that wireless devices can communicate with information processor 102 using wireless data communication connections (e.g., Wi-Fi).

System 100 preferably includes software that provides functionality described in greater detail herein, and preferably resides on one or more information processor 102 and/or user computing devices 104. One of the functions performed by information processor 102 is that of operating as a web server and/or a web site host. Information processor 102 typically communicate with communication network 106 across a permanent i.e., unswitched data connection 108. Permanent connectivity ensures that access to information processor 102 is always available.

FIG. 1B is a block diagram illustrating an arrangement of hardware and corresponding parties in connection with managing information received from parties that are responsible for the collection and review of assets, and that are responsive to discovery requests. Further the hardware and parties identified in FIG. 1B provide tracking and managing of custodians and the collection of assets in their possession that are potentially relevant to a discovery request. The arrangement shown in FIG. 1B is useful for optimizing one or more responses to discovery requests, such as in connection with a litigation, with a hardware phase-out, or other production requiring information associated with a plurality of custodians and respective assets. The system is generally arranged or otherwise configured to implement the above-described discovery optimization process and can comprise an information processor 102 (e.g., a discovery management server), a computer network (such as the Internet) 106, at least one custodian 154 and one or more reviewers 162. The information processor 102 creates and maintains information regarding custodians 154, assets 156 and reviewers 162 responsible for the collection and processing of assets 156 from the custodians 154, for example, as digital data in a memory, a database, a file, or a combination of the foregoing. A given custodian 154 maintains a digital storage device, such as a hard drive, flash drive, etc. that is operative to store one or more assets 156. Using a schedule, a master control component can schedule the collection of assets from custodians and makes such information available for analysis or processing by a reviewer 162. The master control component can receive information regarding analysis or processing performed by a given reviewer 162, which is maintained in an appropriate data store, e.g., an assets data store. Such a system having the master control component utilizes the so-created and maintained digital data and to control discovery-related processes and workflows, under control of a programmed processor, to better ensure efficient use of the processing power of the system, the network resources consumed by distributing and otherwise providing to users the salient information regarding the status of discovery requests, including the extent to which requests have been satisfied.

In one or more implementations, a programmable processor executing software controls the collection and processing of one or more assets 156 by one or more respective reviewers 162. For example, instructional input is received from a reviewer. In response, digital data are created, managed and distributed in connection with management of the discovery assets. A programmable processor, such as a programmable processor under the control of the reviewer 162 or a different programmable processor, is in control of tracking the collection of the identified one or more assets in possession of the one or more custodians and at least part of the digital data creation. According to one embodiment, tracking comprises receiving feedback, other data, or both from a given reviewer 162 with regard to his or her review of a given asset 156 and maintaining that digital data in a memory, a database, a file, or a combination of the foregoing. Furthermore, the addition or removal of custodians 154 over a period of time can be managed by the programmed processor(s) such that program code executing on a programmable processor can modify the collection, processing and tracking in response to the addition or removal of custodians over the period of time such that the response to discovery requests is optimized.

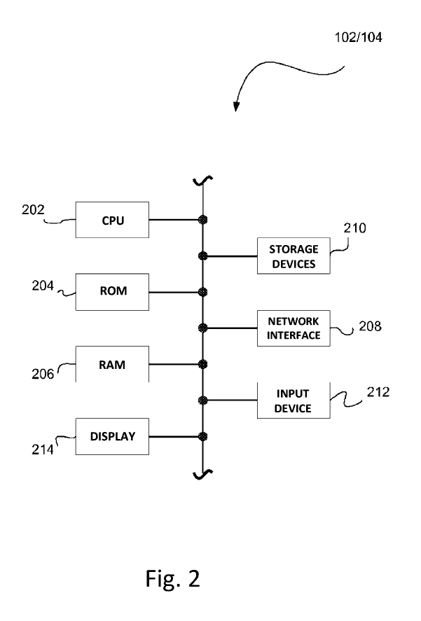

FIG. 2 illustrates example functional elements of each information processor 102 or user computing device 104, and preferably includes one or more processors 202 used to execute software code in order to control operation of information processor 102/user computing device 104, read only memory (ROM) 204, random access memory (RAM) 206 or any other suitable volatile or non-volatile computer readable storage medium, which can be fixed or removable. FIG. 2 also includes one or more network interfaces 208 to transmit and receive data to and from other computing devices across a communication network. The network interface 208 can be any interface that enables communication between the any of the devices (e.g., 102 or 104) shown in FIG. 1A includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting the devices and/or communication networks, such as private networks and the Internet. Such connections can include a wired connection or a wireless connection (e.g., using the IEEE 802.11 standard known in the relevant art) though it should be understood that network interface 208 can be practically any interface that enables communication to/from the processor 202.

Continuing with reference to FIG. 2, storage device(s) 210 can be included such as a hard disk drive, floppy disk drive, tape drive, CD-ROM or DVD drive, flash memory, rewritable optical disk, rewritable magnetic tape, or some combination of the above for storing program code, databases and application code. In certain implementations, memory 204, 206 and/or storage device(s) 210 are accessible by the processor 202, thereby enabling the processor 202 to receive and execute instructions stored on the memory 204, 206 and/or on the storage 210. Further, elements include one or more input devices 212 such as a keyboard, mouse, track ball and the like, and a display 214. The display 214 can include a screen or any other such presentation device that enables the system to instruct or otherwise provide feedback to the user regarding the operation of the system 100. By way of example, display 214 can be a digital display such as an LCD display, a CRT, an LED display, or other such 2-dimensional display as would be understood by those skilled in the art. By way of further example, a user interface and the display 214 can be integrated into a touch screen display. Accordingly, the display is also used to show a graphical user interface, which can display various data and provide “forms” that include fields that allow for the entry of information by the user. Touching the touch screen at locations corresponding to the display of a graphical user interface allows the user to interact with the device to enter data, control functions, etc. So, when the touch screen is touched, interface communicates this change to processor, and settings can be changed or user entered information can be captured and stored in the memory.

One or more software modules can be encoded in the storage device(s) 210 and/or in the memory 204, 206. The software modules can comprise one or more software programs or applications having computer program code or a set of instructions executed in the processor 202. Such computer program code or instructions for carrying out operations or aspects of the systems and methods disclosed herein can be written in any combination of one or more programming languages, as would be understood by those skilled in the art. The program code can execute entirely on one computing device (e.g., information processor 102) as a stand-alone software package, partly on one device and partly on one or more remote computing devices, such as, a user computing device 104, or entirely on such remote computing devices. In the latter scenario and as noted herein, the various computing devices can be connected to the information processor 102 through any type of wired or wireless network, including a local area network (LAN) or a wide area network (WAN), or the connection can be made to an external computer (for example, through the Internet using an Internet Service Provider). It should be understood that in some illustrative embodiments, one or more of the software modules can be downloaded over a network from another device or system via the network interface 208. For instance, program code stored in a computer readable storage device in a server can be downloaded over a network from the server to the storage 210.

It is to be appreciated that several of the logical operations described herein are implemented (1) as a sequence of computer implemented acts or program modules running on the various devices of the system 100 and/or (2) as interconnected machine logic circuits or circuit modules within the system 100. The actual implementation is a matter of design choice dependent on the requirements of the device (e.g., size, energy, consumption, performance, etc.). Accordingly, the logical operations described herein are referred to variously as operations, steps, structural devices, acts, or modules. As referenced above, the various operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Thus, the various components of information processor 102 need not be physically contained within the same chassis or even located in a single location. For example, as explained above with respect to databases which can reside on storage device 210, storage device 210 may be located at a site which is remote from the remaining elements of information processor 102, and may even be connected to CPU 202 across communication network 106 via network interface 208.

The nature of the present application is such that one skilled in the art of writing computer executed code (software) can implement the described functions using one or more or a combination of a popular computer programming languages and technologies including, but not limited to, C++, VISUAL BASIC, JAVA, ACTIVEX, HTML, XML, ASP, SOAP, IOS, ANDROID, TORR and various web application development environments.

As used herein, references to displaying data on user computing device 104 refer to the process of communicating data to the computing device across communication network 106 and processing the data such that the data can be viewed on the user computing device 104 display 214 using a web browser or the like. The display screens on user computing device 104 present areas within discovery asset management system 100 such that a user can proceed from area to area within the discovery asset management system 100 by selecting a desired link. Therefore, each user's experience with discovery asset management system 100 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of discovery asset management system 100.

In one or more implementations, the present application provides electronic discovery information associated with processed metrics for collected assets 156 from each of a plurality of custodians 154 via a data communication platform. The data communication platform can be programmed and configured, for example, as an application executing on one or more computing devices, as an Internet web site, as a plug-in to a software application, or other suitable implementation. In operation, information is received by an information processor 102 from a plurality of devices 104, such as operated and/or maintained by reviewers 162, and that represents metrics associated with respective ones of assets 156 operated and/or maintained by custodians 154. The metrics can represent specific details of an asset 156 and/or degrees of completion of specific tasks, such as in connection with forensic analytics associated with an asset or an element thereof. For example, metrics can be associated with a tablet computing device, a smartphone, a laptop computer, or an MICROSOFT EXCHANGE mailbox. The metrics can represent features associated with assets 156, such a type of an asset, an operating system of an asset, an amount of storage space of an asset and a transfer rate associated with an asset.

Metric information that is received, for example, by an information processor 102 can be provided with information representing an event associated with one or more assets 156. For example, before, during and/or after an asset 156 is collected and/or examined, when forensics are being performed and/or when some other event occurs associated with an asset, information associated with the event can be packaged with metric information and transmitted for reception by the information processor 102. In one or more implementations, software instructions can be configured to execute on one or more devices, including computing devices operated by reviewers 162 and/or the assets 156 themselves. Upon detection and/or received information of an event, such as that an asset 156 has been accessed or that forensic activity associated with an asset 156 has commenced or is completed, information can be generated and formatted for transmission, for example, to information processor 102. The software instructions can be configured as a broadcaster and can take various forms, such as a plug-in, add-in, extension or the like, that operate with an existing computer program, including a web-browser software application. In addition or in the alternative, the broadcaster can be configured as a polling system that communicates with the information processor 102 or other device via one or more application programming interfaces (“API”) 105.

The event information received by the information processor 102 is, thereafter, processed. As a function of the processing, a time and/or a cost completion estimation associated with forensic activity is determined. For example, following collection of assets 156 in possession or otherwise maintained by each of a plurality of custodians 154, information representing a total sum of data acknowledged to be in possession of a reviewer 162 is received. Other variables, such as physical storage size(s), transfer rates (e.g., i/o rates), as well as information representing previously performed forensic activity from respective ones of reviewers 162′ and/or forensic activity performed for similar or the same kinds of asset 156, can be factored to predict completion times and/or costs. For example, information associated specific brands, models, device identifiers, operating systems and/or software applications can be taken into consideration in connection with time and/or cost completion estimations. Information, such as metrics, can be stored on one or more databases that are directly and/or indirectly accessible to information processor 102, and usable in such determinations.

In one or more implementations, requests can be received by the information processor 102 for information associated with electronic discovery. In response to the requests, electronic discovery information can be prepared that includes the time and/or cost completion estimations for at least one of the collected assets 156. The prepared electronic discovery information can be, thereafter, provided to each of the respective requesting devices via the data communication platform. For example, a web-based interface can be provided that registered users log into and retrieve respective information regarding a particular discovery production. Such information can include responses to specific queries and/or requests associated with a discovery production, one or more reviewers 162, one or more assets 156 and/or one or more custodians 154.

Accordingly, information processed and determined by the present application can be particularly useful in connection with assessing particular contexts. For example, upon conducting one or more time and/or cost benefits associated with electronic discovery, a determination can be made whether it would be cost-effective to accept a settlement offer. Calculations that are based on assets 156, as well as time and resources needed to complete a project, support informed decision-making. One or more devices can be queried to obtain prior custodian lists, and to assess and track acknowledgements associated with collections of assets 156 associated therewith, for example, to determine what may be involved or required in connection with collections and in particular contexts.

The interactive data communication platform of the present application enables up-to-the-minute dissemination of information in connection with electronic discovery. Cost schedules, production schedules, specific assets 156 and/or custodian 154 information can be accessed and/or calculated. For example, an assessment has been made that sixty terabytes of data need to be processed in order to complete a respective discovery request. Even though only a relatively small percentage of information regarding the request is provided via the interactive data communication platform, such two-three terabytes of the sixty terabytes, the information processor 102 can accurately estimate time/cost of completion for all sixty terabytes.

Moreover, the present application can include modules that configure the information processor 102 to compare information (e.g., historical models and statistics) associated with completion of forensic and other activity in connection with assets 156. For example, a specific model of smartphone may have previously required three hours to certify completion of forensic activity, which lends for an accurate assessment of a similar, albeit not identical, asset 156 undergoing current examination by a reviewer 162. A calculation can be made based on time/date of entry, e.g., where a unit is applied, and a monetary value can be calculated, e.g., by hour, by gigabyte or other unit can be extrapolated.

The present application further includes functionality to enable assessment of respective reviewers 162, including in connection with specific assets 156. For example, based on previously gathered metrics and respective processing performed by information processor 102, a first reviewer 162 may be particularly efficient and accurate when working with smartphones running all versions of APPLE iOS, but that same reviewer 162 may be particular inefficient and inaccurate when working with large MICROSOFT EXCHANGE servers and corresponding virtual user “mailboxes” (in-box, sent-items, or the like). Given the plethora of makes and models of assets 156, as well as particular configurations of the assets (e.g., RAM, storage space, processing power), operating systems, applications, and the like, there can be tremendous disparity between reviewers and the present application provides new solutions for capturing that information and presenting it in a new platform.

In one or implementations, options (e.g., switches) can be provided via software executing on various user computing devices 104 to enable broadcast of information, such as representing completion of e-discovery performed by respective reviewers 162 and for particular assets 156. Moreover, such information can be provided “publicly” or “privately.” Privately provided information may regard, for example, information within an organization and behind a firewall. Publicly provided information, may be “verified” or “anonymous,” such that users can identify specific reviewers 162 and specific assets 156 that were processed (i.e., verified). Alternatively, information on reviewers 162 and assets 156 may be provided as metrics or in another summary format (i.e., anonymously), such as categorized by task, by completion, or other useful grouping. Publicly provided metrics can result in anonymous (other) users to gauge the effectiveness of a respective reviewer 162 to complete a particular task.

The present application can further provide for ranking of reviewers 162 and respective tasks performed by respective reviewers, as a function of assessments of specific reviewers and assets 156, such as shown and described herein. For example, upon receipt and processing of information associated with the collection of assets 156 and e-discovery actions taken in connection therewith, particular strengths and weaknesses in connection specific reviewers 162 and respective collections and assets 156 can be made. As a function of the ranking, the present application can include modules that, when implemented by information processor 102, results in specific reviewers 162 being assigned to specific tasks, thereby providing for customized teams for electronic discovery comprising multiple reviewers 162. In this way, teams of respective reviewers 162 can be built, each having particular expertise, for e-discovery tasks associated with respective assets 156. The information used to define such teams is usable as a form of leverage in the event that one or more reviewers 162 resists working in conjunction with other, potentially unrelated, reviewers 162 in a given discovery production. It is recognized, however, that evidence showing cost effectiveness, time efficiency and/or quality of work can be particularly effective to persuade such reviewers 162 to comply and agree to be part of a custom team of reviewers 162.

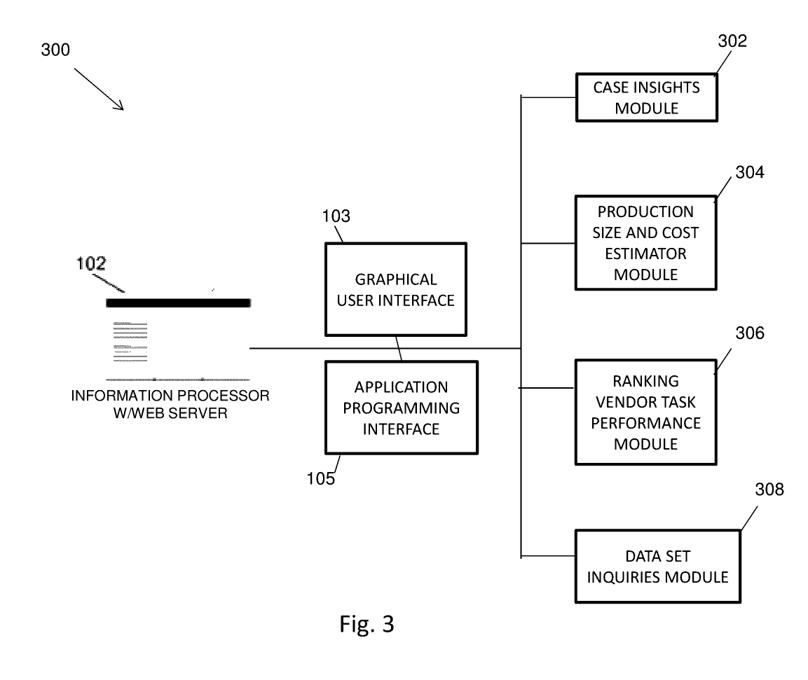

Referring now to FIG. 3, a block diagram showing information processor 102, graphical user interface 103 and application programming interface(s) 105 is provided, with a series of modules that can be implemented to configure information processor 102 in accordance with the teachings herein. For example, case insights module 302 can be provided that includes instructions to configure information processor 102 to receive metrics from a user computing device 104 client metric broadcaster. One or more services, as well as task sources, can configure information processor 102 to provide valuable insight into the status of an e-discovery project. In accordance with the teachings herein, such metric broadcasters can be installed into various systems used to handle work requirements associated with identifying respective custodians 154, as well as the collection and processing of assets 156. For example, hold acknowledgement checklists, collection project completion estimates, specific processing completion estimates (e.g., time/money), review statistics and completion estimates can be determined and, thereafter, displayed via the data communcation platform, for example, for review by a project team. Various statistics can calculated and provided, such as effective reviewer(s) 162, effective review group(s), reviewer(s) 162 having erroneous decision(s), review group(s) 162 having the most erroneous decisions, and respective review status identifiers, such as: asset(s) reviewed/asset(s) remaining/non-private (public) remaining/and private remaining.

Continuing with reference to FIG. 3, production size and cost estimator module 304 is illustrated, which includes programming code that, when executed, configures information processor 102 to monitor one or more review sets and the reviewers 162 in progress, including as a function of metric broadcasters. As noted herein, information associated therewith is useful for determining an amount of remaining records that are likely to be subject to production. Using such collected information and inputs associated with the production cost schedule, the present application is usable to create a preview calculator that gives a rolling estimation of the costs involved in completing productions against a current dataset in connection with a given e-discovery production.

In addition to modules 302 and 304, ranking reviewer task performance module 306 can be provided that configures information processor 102 to receive information associated with users who publish their respective task completion details, such as by verified user or anonymously. When a user completes a particular type of task, (s)he can reference specific reviewers 162 that have handled the same or similar type of task before, e.g., APPLE MACINTOSH computer collection, smartphone collections, or the like. As noted herein, task completion metrics help for making assignment decisions based on all available feedback, including publicly and privately provided information.

Accordingly, the present application provides for a form of public and private crowd sourced data for details on previous task completion, thereby enabling for the determinations and informed decisions associated with assigning respective reviewers 162 to specific tasks.

Some scenarios that embodiments of the present invention are configured to address include, but are not limited to, managing individuals responsible for the collection and review from custodians 154 that are responsive to discovery requests, as well as tracking and otherwise managing custodians 154 and the collection of assets 156 that are potentially relevant to a discovery request. In one or more implementations, a pseudo-programming or query language is provided or otherwise supported that enables users to submit specific questions, for example, via the data communication platform. The queries can be processed, for example, by information processor 102 (e.g., a data server), and responses thereto can be provided substantially in real-time. In this manner, the server optimizes the analysis and processing of assets that are responsive to a discovery request.

Moreover, the present application can include data set inquiries module 308, that configures information processor 102 to receive, from a user computing device 104 configured with a connector, such as a client-side service API, to perform ad-hoc searches. The module 308 configures the information processor 102 to process such search requests and return results back, such as via a project log.

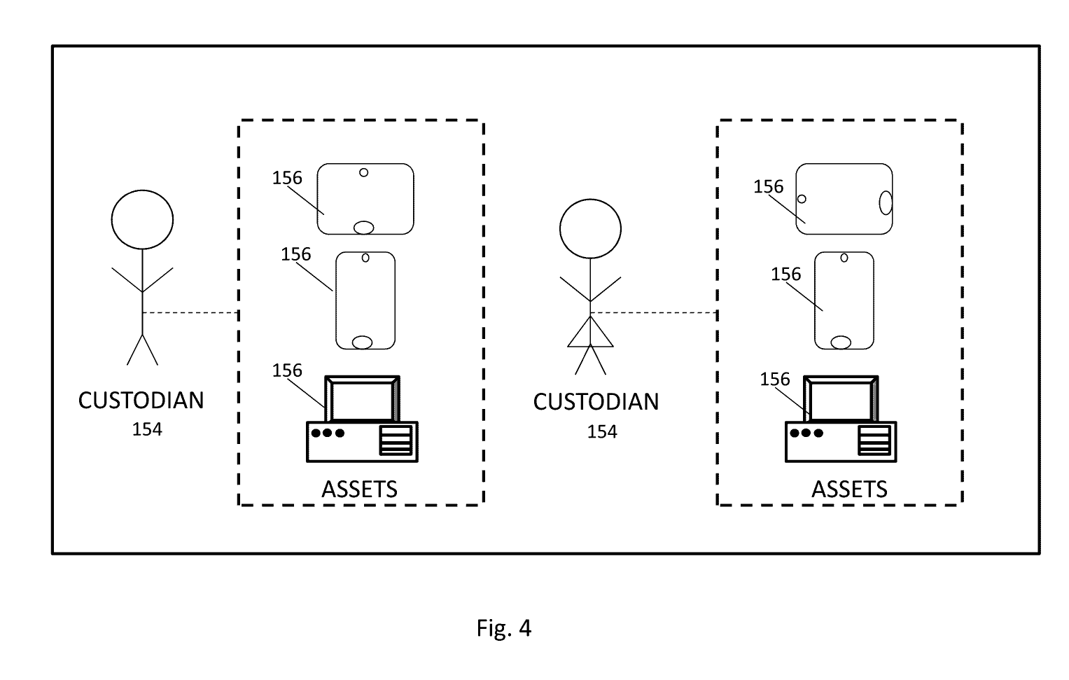

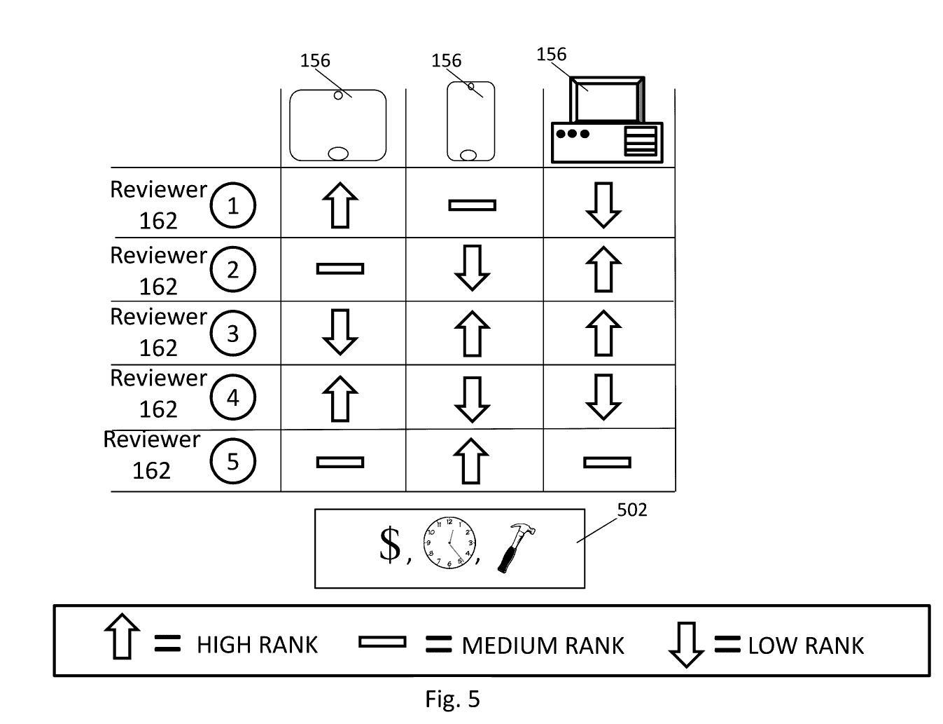

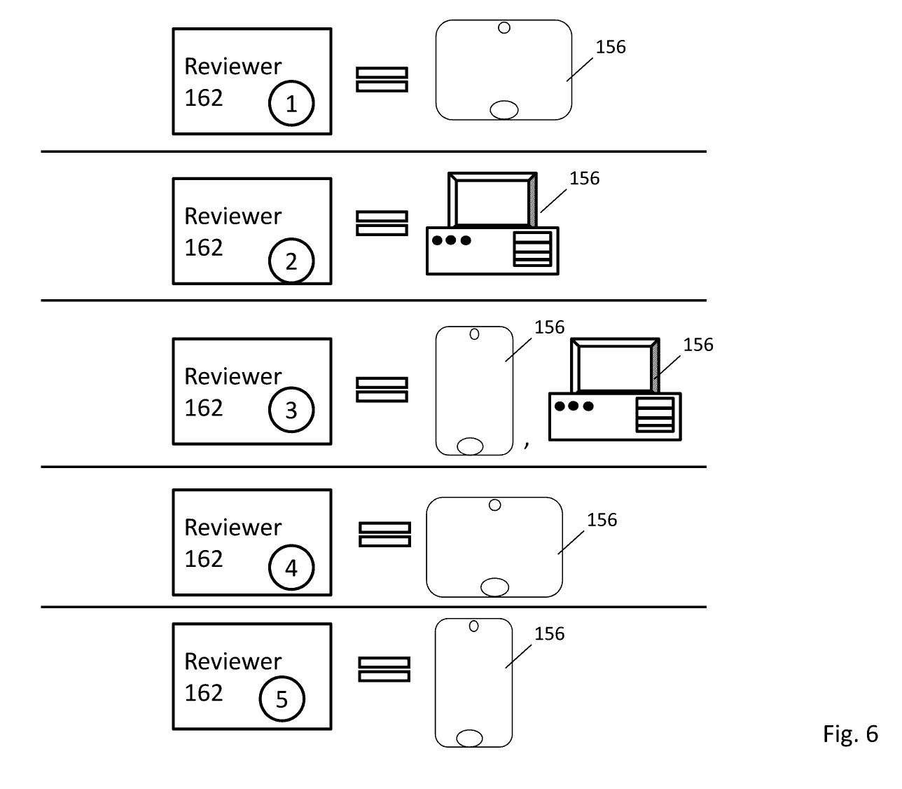

FIGS. 4-6 provide graphical representations of custodians 154 and assets 156, and features of the present application associated with ranking reviewers 162 in connection with specific assets and building of specific teams of reviewers 162, even those that may not be part of one or more respective organizations (e.g., vendor companies). FIG. 4, for example, illustrates two custodians 154, each having respective assets 156. FIG. 5 illustrates an example table associated with ranking information associated with respective reviewers 162 and assets 156. In the example shown in FIG. 5, reviewer 162 #1 is ranked high for an asset 156 that is a tablet computing device, ranked medium for a smartphone, and ranked low in connection with a server computing device. In the example shown in FIG. 5, ranking 502 is provided as a function of cost, time and quality of work. FIG. 6 illustrates results of the ranking process, as well as an assemblage of respective reviewers 162 to form teams in connection with the assets identified in FIGS. 4 and 5.

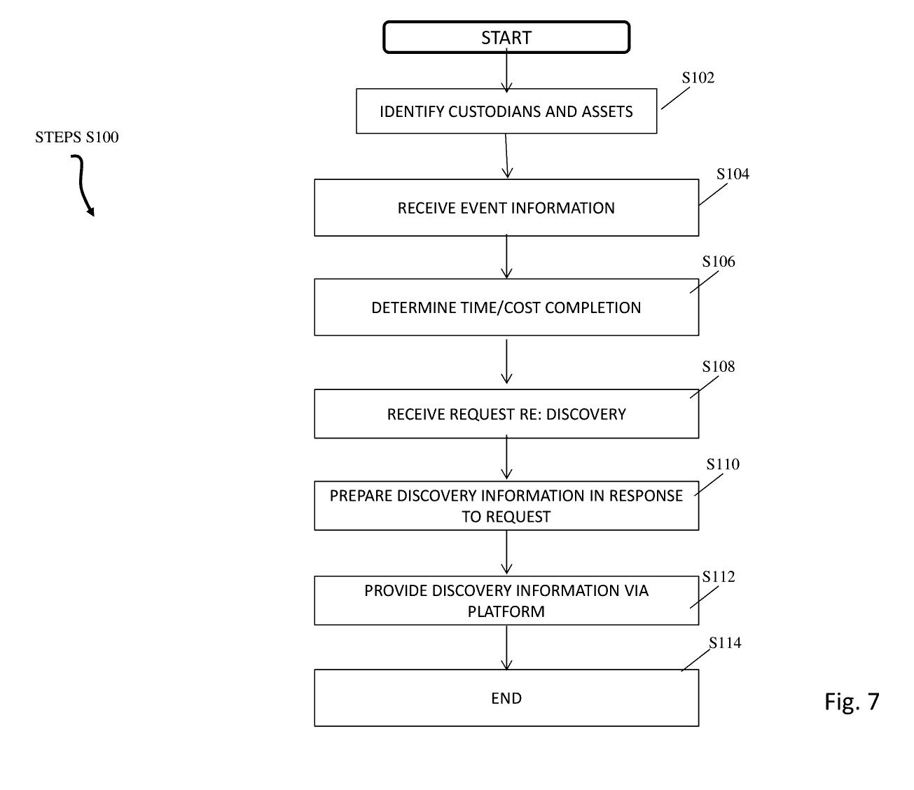

FIG. 7 is a flow chart illustrating example steps S100 that are associated with providing, via a data communication platform, electronic discovery information, in accordance with an example implementation of the present application. It should be appreciated that several of the logical operations described herein are implemented (1) as a sequence of computer implemented acts or program modules running on a communication device and/or (2) as interconnected machine logic circuits or circuit modules within a communication device. The implementation is a matter of choice dependent on the requirements of the device (e.g., size, energy, consumption, performance, etc.). Accordingly, the logical operations described herein are referred to variously as operations, structural devices, acts, or modules. Several of these operations, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

In the example steps shown in FIG. 7, the process begins at step S102 and custodians 154 and assets 156 are identified. Thereafter, event information representing metrics associated with respective ones of the assets is received (step S104). At step S106, a determination is made regarding time and/or cost of completion, and thereafter a request regarding the discovery production is received (step S108). In response to the request, discovery information is prepared (step S110), and thereafter, the discovery information is provided via the data communication platform (step S112). Thereafter, at step S114, the process ends.

Thus, as shown and described herein the present application provides for flexible implementations, including that are associated with providing, via a data communication platform, electronic discovery information. The present application provides for a technological improvement in the discovery production industry, and results in improvements in efficiency, speed and accuracy. Accordingly, the present application provides for significant improvement over known measures by providing standards that collectively include a framework for identifying custodians and assets, and for providing information associated therewith.

The subject matter described above is provided by way of illustration only and should not be construed as limiting. Various modifications and changes can be made to the subject matter described herein without following the example embodiments and applications illustrated and described, and without departing from the true spirit and scope of the present invention, as set forth in each and any of the following claims.

What is claimed:

1. A method for providing, via a data communication platform, electronic discovery information associated with processed metrics for collected assets from a plurality of custodians, the method comprising:
identifying, by a processor configured by executing code, a plurality of custodians associated with electronic discovery and a plurality of respective assets that have been maintained by the custodians;
receiving, by the processor over a communication network from a plurality of computing devices, event information representing metrics associated with respective ones of the assets, wherein the metrics include physical specifications of each of the respective assets and include third party reviewer forensic activity in relation to each of the respective assets;
determining, for each of the respective asset(s) by the processor as a function of processing the event information, a time and/or cost completion estimation associated with the forensic activity;
receiving, by the processor over a communication network from a computing device via the data communication platform, a request associated with the electronic discovery;
preparing, by the processor in response to the request, the electronic discovery information that includes the time and/or cost completion determination for at least one of the collected assets; and
providing, by the processor in response to the request over a communication network, the electronic discovery information.

2. The method of claim 1, wherein receiving the event information further comprises:
providing, by the processor, a metric broadcaster that executes on each of a plurality of computing devices and configures each of the plurality of computing devices to:
determine an occurrence of forensic activity for respective ones of the assets;
generate the event information for transmission; and
transmit the event information to the processor over the communication network;
determining, by the processor, that the event information has been received; and
accessing, by the processor, the event information for processing.

3. The method of claim 2, wherein the metric broadcaster is configured as a plug-in.

4. The method of claim 2, wherein the metric broadcaster is configured as a polling system that communicates with the processor via an application programming interface.

5. The method of claim 1, wherein determining the time and/or cost completion estimation further comprises:
correlating, by the processor, the received information with stored metric information associated with a similar asset and/or similar forensic activity.

6. The method of claim 1, wherein the collected assets include at least one device selected from a group consisting of:
a smartphone;
a tablet computing device;
a laptop computing device;
a desktop computing device;
a server computing device;
a module in a vehicle; and
a portable entertainment device.

7. The method of claim 1, wherein the event information includes brand information, model information, device identification information, storage size, and/or transfer rate.

8. The method of claim 1, further comprising:
performing, by the processor, a cost/benefit analysis as a function of a value representing a settlement offer and at least one completion estimate; and
provide, to at least one computing device via the data communication platform, the cost/benefit analysis.

9. The method of claim 1, further comprising:
identifying, by the processor, for each of the respective assets and/or forensic activity in relation to the assets, a respective third-party reviewer to perform the respective forensic activity.

10. The method of claim 9, wherein the step of identifying a respective third-party reviewer comprises:
identifying, by the processor, forensic activity performed by a plurality of respective third-party reviewers for previously collected assets;
ranking, by the processor, the plurality of respective third-party reviewers as a function of the identified forensic activity and the previously collected assets; and
selecting the respective ones of the respective third-party reviewers as a function of the ranking.

11. The method of claim 10, wherein the ranking is based on expertise, efficiency and/or cost.

12. The method of claim 1, wherein the custodians are members of an organization.

13. The method of claim 1, further comprising:
receiving, by the processor via the data communication platform from a computing device, a query associated with the custodians and/or the assets;
accessing, by the processor, stored information associated with the custodians and/or the assets associated with the query; and
providing, by the processor via the data communication platform, a response to the query as a function of the accessed information.

14. A system for providing, via a data communication platform, electronic discovery information associated with processed metrics for collected assets from a plurality of custodians, the system comprising:
at least one processor configured to execute instructions stored on processor readable media that configure the at least one processor to:
identify a plurality of custodians associated with electronic discovery and a plurality of respective assets that have been maintained by the custodians;
receive, over a communication network from a plurality of computing devices, event information representing metrics associated with respective ones of the assets, wherein the metrics include physical specifications of each of the respective assets and include third party reviewer forensic activity in relation to each of the respective assets;
determine, for each of the respective asset(s) as a function of processing the event information, a time and/or cost completion estimation associated with the forensic activity;
receive, over a communication network from a computing device via the data communication platform, a request associated with the electronic discovery;
prepare, in response to the request, the electronic discovery information that includes the time and/or cost completion determination for at least one of the collected assets; and
provide, in response to the request over a communication network, the electronic discovery information.

15. The system of claim 14, wherein the processor is further configured to receive the event information by:
providing, a metric broadcaster that executes on each of a plurality of computing devices and configures each of the plurality of computing devices to:
determine an occurrence of forensic activity for respective ones of the assets;
generate the event information for transmission; and
transmit the event information to the processor over the communication network;
determine that the event information has been received; and
access the event information for processing.

16. The system of claim 15, wherein the metric broadcaster is configured as a plug-in.

17. The system of claim 15, wherein the metric broadcaster is configured as a polling system that communicates with the processor via an application programming interface.

18. The system of claim 14, wherein the processor is further configured to determine the time and/or cost completion estimation by:
correlating, the received information with stored metric information associated with a similar asset and/or similar forensic activity.

19. The system of claim 14, wherein the collected assets include at least one device selected from a group consisting of:
a smartphone;
a tablet computing device;
a laptop computing device;
a desktop computing device;
a server computing device;
a module in a vehicle; and
a portable entertainment device.

20. The system of claim 14 wherein the event information includes brand information, model information, device identification information, storage size, and/or transfer rate.

21. The system of claim 14, wherein the processor is further configured to:
perform a cost/benefit analysis as a function of a value representing a settlement offer and at least one completion estimate; and
provide, to at least one computing device via the data communication platform, the cost/benefit analysis.

22. The system of claim 14, wherein the processor is further configured to:
identify, for each of the respective assets and/or forensic activity in relation to the assets, a respective third-party reviewer to perform the respective forensic activity.

23. The system of claim 23, wherein the processor is further configured to identify a respective third-party reviewer by:
identifying forensic activity performed by a plurality of respective third-party reviewers for previously collected assets;
ranking the plurality of respective third-party reviewers as a function of the identified forensic activity and the previously collected assets; and
selecting the respective ones of the respective third-party reviewers as a function of the ranking.

24. The system of claim 23, wherein the ranking is based on expertise, efficiency and/or cost.

25. The system of claim 14, wherein the custodians are members of an organization.

26. The method of claim 1, wherein the processor is further configured to:
receive, via the data communication platform from a computing device, a query associated with the custodians and/or the assets;
access stored information associated with the custodians and/or the assets associated with the query; and
provide, via the data communication platform, a response to the query as a function of the accessed information.
